(19) United States
(12) Patent Application Publication
(10) Pub. No.: US 2007/0036463 A1
(43) Pub. Date: Feb. 15, 2007

(54) Platform-independent preference setting method

(76) Inventor: Lu-Kang Mao, Hsinchu (TW)

Correspondence Address: KIRTON AND MCCONKIE, 60 EAST SOUTH TEMPLE,, SUITE 1800, SALT LAKE CITY, UT, 84111, US

(21) Appl. No.: 11/490,375

(22) Filed: Jul. 20, 2006

(30) Foreign Application Priority Data
Aug. 10, 2005 (TW) 094127228

(51) Int. Cl. G06K 9/36

(52) U.S. Cl. 382/284; 84/609

(57) ABSTRACT

A platform-independent preference-setting method is used between a first electronic device, a second electronic device and a portable storage medium. The second electronic device includes a built-in memory. In the platform-independent preference-setting method, the portable storage medium is inserted into the first electronic device, which has been installed therein a first application program; the first application program is executed to generate a set of preference-setting parameters and to store the set of preference-setting parameters into the portable storage medium; the portable storage medium is removed from the first electronic device and is inserted into the second electronic device, which has been installed therein a second application program; and, said second application program is executed to read at least one parameter of the set of preference-setting parameters and to store the at least one parameter into the built-in memory of the second electronic device at a preset address.

### FIELD OF THE INVENTION

The present invention relates to a platform-independent preference setting method, and more particularly to a platform-independent preference setting method used between a first electronic device, a second electronic device and a portable storage medium.

### BACKGROUND OF THE INVENTION

Recently, the general trends in designing information electronic devices are toward small size, light weightiness and easy portability. The information electronic devices such as mobile phones, personal digital assistants, digital still cameras, digital video cameras and the like have nonvolatile memories therein. Due to their small size, high recoding capacity, high reading speed, excellent impact resistance and good tolerance to broad temperature and humidity range, flash memory cards are the most popular nonvolatile memories. In addition to use with the portable information electronic devices, the flash memory cards are also applicable to the domestic DVD players, video game console, vehicular audio equipment, personal computers, notebook computers and so on. As a consequence, flash memory cards have experienced great growth and are rapidly gaining in popularity.

Nowadays, most commercial electronic devices are designed to meet the requirement of user-friendliness. In other words, some operating parameters or operating conditions can be determined or adjusted according to the users' preferences or habits. Take a mobile phone for example. The mobile phone 10 of FIG. 1 comprises a nonvolatile memory 101, a key pad 102 (including for example up/down keys and a confirmation key), a display screen 103 and a function option operation interface 104. The function option operation interface 104 is shown on the display screen 103. Via the function option operation interface 104, the user may set up the preference-setting parameters such as the startup logo setting, the time setting of operator logo, the systematic interface language option, the ring tone option, the personal information, the address book and so on. These preference-setting parameters are saved as setting files or media files in the nonvolatile memory 101. An exemplary nonvolatile memory 101 is a flash memory card, which is usually built in the mobile phone 10. As known, even if power is switched off, the contents of the flash memory card are still retained. That is, if the mobile phone 10 is switched off, the parameters set by the user are retained.

Nowadays, most people may simultaneously carry one or more information electronic devices. Since the operation platforms used with various information electronic devices are likely different, the user should set up the preference-setting parameters in the information electronic devices according to the types of operation platforms. As previously described, for the same user, the preference-setting parameters such as the startup logo setting, the time setting of operator logo, the systematic interface language option, the ring tone option, the personal information and the address book are substantially identical or slightly changed. The complicated processes of setting up the substantially identical or slightly changed preference-setting parameters in the information electronic devices become hindrance from using the information electronic devices. Moreover, since the operation interfaces are diverse, the processes of setting up the preference-setting parameters are inconvenient and time-consuming.

### SUMMARY OF THE INVENTION

The present invention provides a platform-independent preference setting method used between a first electronic device, a second electronic device and a portable storage medium to interchange preference-setting parameters between different operation platforms in a simplified and time-saving manner.

In accordance with an aspect of the present invention, there is provided a platform-independent preference setting method used between a first electronic device, a second electronic device and a portable storage medium, the second electronic device having a built-in memory therein, the platform-independent preference setting method comprising steps of: inserting the portable storage medium into the first electronic device, which has been installed therein a first application program; executing said first application program to generate a set of preference-setting parameters and storing the set of preference-setting parameters into the portable storage medium; removing the portable storage medium from the first electronic device and inserting the portable storage medium into the second electronic device, which has been installed therein a second application program; and, executing said second application program to read at least one parameter of the set of preference-setting parameters and storing the at least one parameter into the built-in memory of the second electronic device at a preset address.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram illustrating the configuration of a mobile phone;

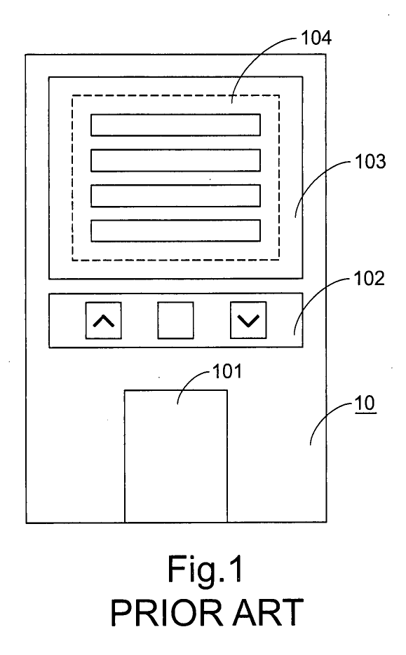

FIGS. 2(a) and 2(b) are schematic functional block diagrams illustrating a platform-independent preference setting method used between a first electronic device, a second electronic device and a portable storage medium according to a first preferred embodiment of the present invention;

FIGS. 3(a) and 3(b) are schematic functional block diagrams illustrating a platform-independent preference setting method used between a first electronic device, a second electronic device and a portable storage medium according to a second preferred embodiment of the present invention; and

FIGS. 4(a) and 4(b) are schematic functional block diagrams illustrating a platform-independent preference setting method used between a first electronic device, a second electronic device and a portable storage medium according to a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

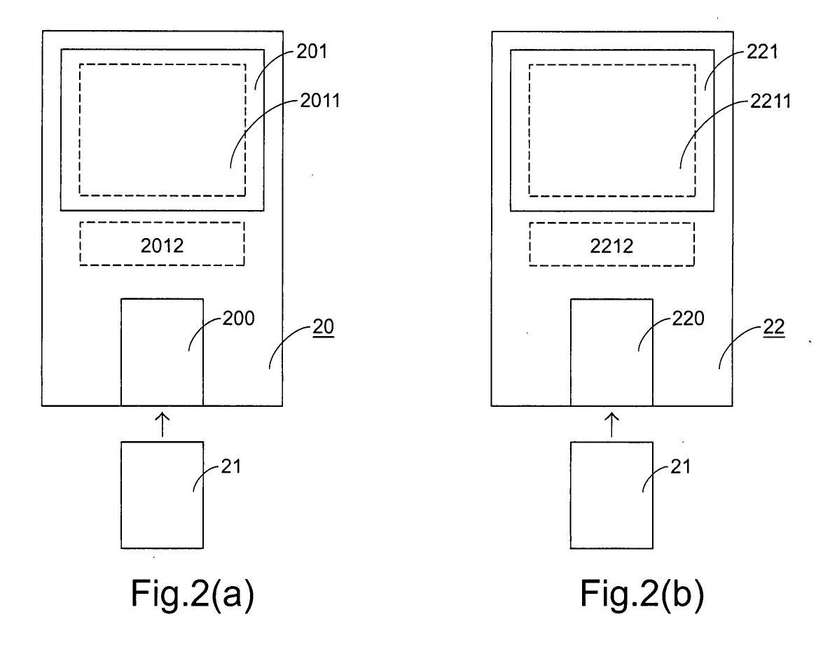

Referring to FIGS. 2(a) and 2(b), schematic functional block diagrams of a platform-independent preference setting method used between a first electronic device, a second electronic device and a portable storage medium according to a preferred embodiment of the present invention are illustrated. In this embodiment, the first electronic device 20 and the second electronic device 22 are a mobile phone and a personal digital assistant, respectively. The portable storage medium 21 is for example a secure digital card (SD card), a MS card, or a Memory Stick Duo. First of all, as shown in FIG. 2(a), the mobile phone 20 has been installed therein a first application program 2012. In response to execution of the first application program 2012, a first function option operation interface 2011 is shown on the display screen 201 of the mobile phone 20. Via the first function option operation interface 2011, the user may input preference setting instruction to generate a set of preference-setting parameters to be stored in the portable storage medium 21, which is inserted in a memory card slot 200 of the mobile phone 20. After the set of preference-setting parameters have been stored into the portable storage medium 21, the portable storage medium 21 can be removed from the memory card slot 200 of the mobile phone 20 and then inserted into the memory card slot 222 of the personal digital assistant 22, as is shown in FIG. 2(b). Meanwhile, the second application program 2212, which has been previously installed in the personal digital assistant 22, will be automatically executed to read and detect the set of preference-setting parameters. After a selection operation is performed, the parameters not executable by the second application program 2212 will be ignored but the parameters executable by the second application program 2212 will be stored into a built-in memory (not shown) of the personal digital assistant 22 at a preset address. Afterward, in response to execution of the second application program 2212, a second function option operation interface 2211 is shown on the display screen 221 of the personal digital assistant 22. Under this circumstance, the preference-setting parameters previously set by the mobile phone 20 can be utilized when the personal digital assistant 22 is operated.

The set of preference-setting parameters are written in a plain text format, for example in an Extensible Markup Language (XML), which is compatible with many different platform platforms. As a consequence, in a case that the first application program and the second application program are executed in two different operation platforms selected from Windows XP, Windows 2000, Mac Os 9, Linux and the like, the preference-setting parameters in the plain text format are allowable to be interchanged between these two different operation platforms.

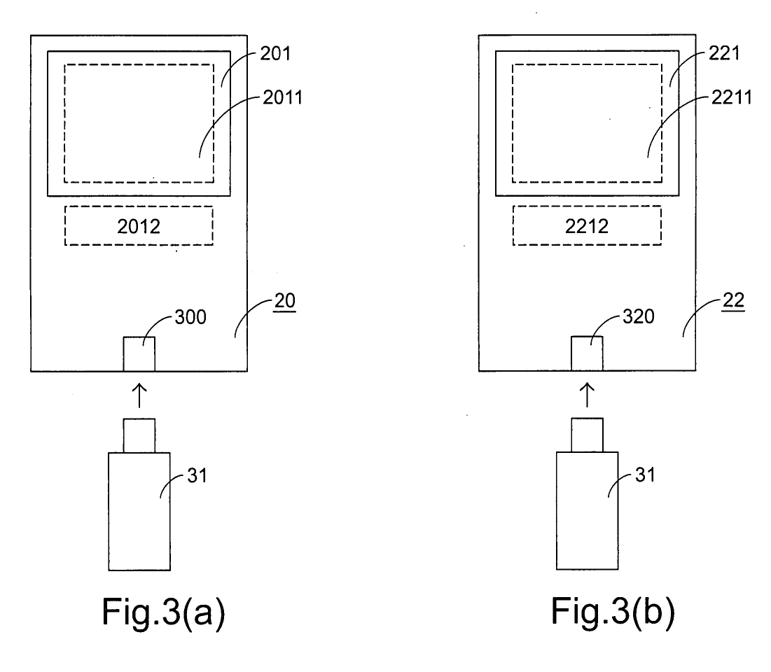

A further embodiment of the platform-independent preference setting method used between a first electronic device, a second electronic device and a portable storage medium according to the present invention is illustrated in FIGS. 3(a) and 3(b). In this embodiment, the portable storage medium 31 is a portable digital data storage device such as a USB flash drive. In addition, the mobile phone 20 and the personal digital assistant 22 have USB connecting ports 300 and 320. Likewise, as shown in FIG. 3(a), when the first application program 2012 is executed, the user may input preference setting instruction via the first function option operation interface 2011 to generate a set of preference-setting parameters to be stored in portable digital data storage device 31, which is inserted in the USB connecting port 300. Then, the portable digital data storage device 31 can be removed from the USB connecting port 300 of the mobile phone 20 and then inserted into the USB connecting port 320 of the personal digital assistant 22, as is shown in FIG. 3(b). Then, the second application program 2212 will be automatically executed to read and detect the set of preference-setting parameters. Afterward, in response to execution of the second application program 2212, the preference-setting parameters previously set by the mobile phone 20 can be utilized when the personal digital assistant 22 is operated.

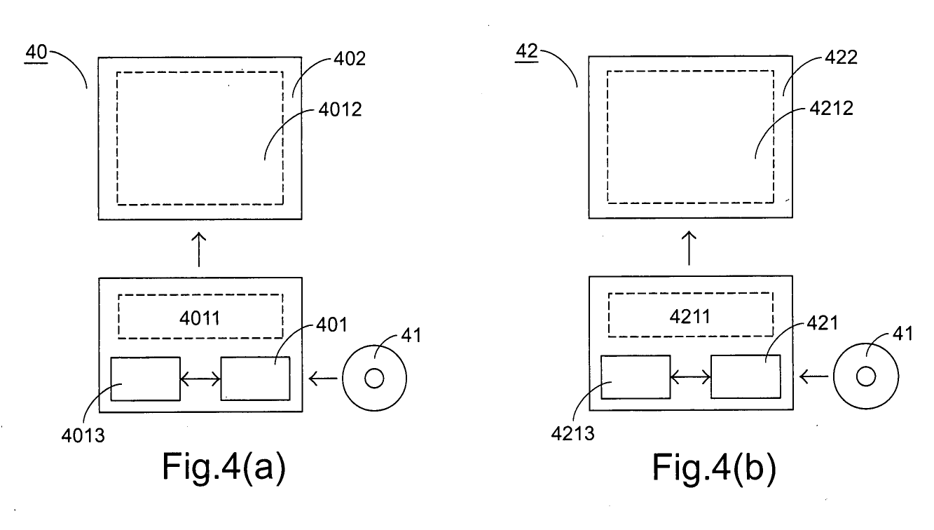

A further embodiment of the platform-independent preference setting method used between a first electronic device, a second electronic device and a portable storage medium according to the present invention is illustrated in FIGS. 4(a) and 4(b). In this embodiment, the first electronic device 40 and the second electronic device 42 are a personal computer and a DVD recorder, respectively. The portable storage medium 41 is for example a recordable disc. The personal computer 40 comprises an optical reading/recording drive 401 and has been installed therein a first application program 4011. In response to execution of the first application program 4011, a first function option operation interface 4012 is shown on the display screen 402 of the personal computer 40. Via the first function option operation interface 4012, the user may input preference setting instruction to generate a set of preference-setting parameters to be stored in the hard disc 4013 of the personal computer 40. After the recordable disc 41 is loaded in the optical reading/recording drive 401, the set of preference-setting parameters will be written into the recordable disc 41. Then, the recordable disc 41 can be removed from the optical reading/recording drive 401 and then loaded into the reading/recording drive 421 of the DVD recorder 42, as is shown in FIG. 4(b). Meanwhile, the second application program 4211, which has been previously installed in the second application program 4211 will be automatically executed to read and detect the set of preference-setting parameters. After a selection operation is performed, the parameters not executable by the second application program 4211 will be ignored but the parameters executable by the second application program 2212 will be stored into a built-in memory 4213 of the DVD recorder 42 at a preset address.

Afterward, in response to execution of the second application program 4211, a second function option operation interface 4212 is shown on the display screen 422 of the DVD recorder 42. Under this circumstance, the preference-setting parameters previously set by the personal computer 40 can be utilized when the DVD recorder 42 is operated.

From the above description, by using the platform-independent preference setting method of the present invention, the preference-setting parameters can be interchanged between different operation platforms. Consequently, the processes of setting up the preference-setting parameters are simplified and time-saving.

The present invention is illustrated by referring to a mobile phone/a personal digital assistant and a personal computer/a DVD recorder. Nevertheless, the present invention can be applied to many electronic devices such as car navigation systems, MP3 portable players, digital still cameras and digital video cameras.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A platform-independent preference setting method used between a first electronic device, a second electronic device and a portable storage medium, the second electronic device having a built-in memory therein, the platform-independent preference setting method comprising steps of:
inserting the portable storage medium into the first electronic device, which has been installed therein a first application program;
executing said first application program to generate a set of preference-setting parameters and storing the set of preference-setting parameters into the portable storage medium;
removing the portable storage medium from the first electronic device and inserting the portable storage medium into the second electronic device, which has been installed therein a second application program; and
executing said second application program to read at least one parameter of the set of preference-setting parameters and storing the at least one parameter into the built-in memory of the second electronic device at a preset address.

2. The platform-independent preference setting method according to claim 1 wherein the first electronic device and the second electronic device are a mobile phone and a personal digital assistant, respectively.

3. The platform-independent preference setting method according to claim 2 wherein the portable storage medium is a memory card.

4. The platform-independent preference setting method according to claim 3 wherein the first electronic device and the second electronic device have respective memory card slots for receiving the memory card therein.

5. The platform-independent preference setting method according to claim 2 wherein the portable storage medium is a USB flash drive.

6. The platform-independent preference setting method according to claim 5 wherein the first electronic device and the second electronic device have respective USB connecting ports for receiving the USB flash drive therein.

7. The platform-independent preference setting method according to claim 1 wherein the first electronic device and the second electronic device are a personal computer and a DVD recorder, respectively.

8. The platform-independent preference setting method according to claim 7 wherein the portable storage medium is a recordable optical disc.

9. The platform-independent preference setting method according to claim 1 wherein said first application program is executed in a first operation platform to generate a first function option operation interface a display screen of the first electronic device.

10. The platform-independent preference setting method according to claim 9 wherein said second application program is executed in a second operation platform to generate a second function option operation interface a display screen of the second electronic device.

11. The platform-independent preference setting method according to claim 1 wherein the set of preference-setting parameters are written in a plain text format.

12. The platform-independent preference setting method according to claim 1 wherein the built-in memory of the second electronic device is a nonvolatile memory.
